(19) United States
(12) Patent Application Publication
(10) Pub. No.: US 2007/0028943 A1
(43) Pub. Date: Feb. 8, 2007

(54) Method of using sulfur fluoride for removing surface deposits

(76) Inventors: Herbert H. Sawin, Chestnut Hill, MA (US); Bo Bai, Cambridge, MA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/497,761

(22) Filed: Aug. 2, 2006

Related U.S. Application Data
(60) Provisional application No. 60/704,852, filed on Aug. 2, 2005.

(51) Int. Cl. B08B 6/00; B08B 9/00

(52) U.S. Cl. 134/1.1; 134/22.1

(57) ABSTRACT

The present invention relates to an improved remote plasma cleaning method for removing surface deposits from a surface, such as the interior of a process chamber that is used in fabricating electronic devices. The improvement involves addition of a nitrogen source to the feeding gas mixture comprising an oxygen source and sulfur fluoride.

### BACKGROUND OF THE INVENTION

1. Field of the Invention

The present invention relates to methods for removing surface deposits by using an activated gas mixture created by remotely activating a gas mixture comprising an oxygen source, sulfur fluoride and nitrogen source. More specifically, this invention relates to methods for removing surface deposits from the interior of a chemical vapor deposition chamber by using an activated gas mixture created by remotely activating a gas mixture comprising an oxygen source, sulfur fluoride and nitrogen source.

2. Description of Related Art

The Chemical Vapor Deposition (CVD) chambers and Plasma Enhanced Chemical Vapor Deposition (PECVD) chambers in the semiconductor processing industry require regular cleaning. Popular cleaning methods include in-situ plasma cleaning and remote chamber plasma cleaning.

In the in-situ plasma cleaning process, the cleaning gas mixture is activated to plasma within the CVD/PECVD process chamber and cleans the depositions in-situ. In-situ plasma cleaning method suffers from several deficiencies. First, chamber parts not directly exposing to the plasma can not be cleaned. Second, the cleaning process includes ion bombardment-induced reactions and spontaneous chemical reactions. Because the ion bombardment sputtering erodes the surfaces of chamber parts, expensive and time-consuming parts replacement are required.

Realizing the disadvantages of in-situ plasma cleaning, the remote chamber plasma cleaning methods are becoming more popular. In remote chamber plasma cleaning process, the cleaning gas mixture is activated by a plasma in a separate chamber other than the CVD/PECVD process chamber. The plasma neutral products then pass from the source chamber to the interior of the CVD/PECVD process chamber. The transport passage may, for example, consists of a short connecting tube and the showerhead of the CVD/PECVD process chamber. In contrast to in-situ plasma cleaning methods, remote chamber plasma cleaning process involves only spontaneous chemical reactions, and thus avoids erosion problems caused by ion bombardment in the process chamber.

Choice of cleaning gas is critical to the plasma cleaning performance. Due to the relatively weak nitrogen-fluorine bond, NF₃ dissociates readily and has been a popular and high efficient cleaning gas. However, NF₃ is toxic, reactive and expensive. It also has to be transported carefully to prevent degradation.

There is a need for alternative cleaning gases which are less expensive and safer but without sacrificing the cleaning performance, e.g., the etching rate.

### BRIEF SUMMARY OF THE INVENTION

The present invention relates to a method for removing surface deposits, said method comprising: (a) activating in a remote chamber a gas mixture comprising an oxygen source, sulfur fluoride and a nitrogen source; and thereafter (b) contacting said activated gas mixture with the surface deposits and thereby removing at least some of said surface deposits.

### BRIEF DESCRIPTION OF THE DRAWING(S)

FIG. 1. Schematic diagram of an apparatus useful for carrying out the present process.

FIG. 2. Plot of the effect to etching rates on silicon nitride with N₂ and NF₃ addition to SF₆+O₂+Ar feeding gas mixture.

FIG. 3. Comparision of NF₃/O₂/Ar system with SF₆/O₂/N₂/Ar system on silicon nitride etching rates.

FIG. 4. Plot of the effect to etching rates on silicon dioxide with N₂ addition to SF₆+O₂+Ar feeding gas mixture.

FIG. 5. X-ray photoelectron spectroscopy (XPS) examination of Sapphire wafer after exposed to SF₆+O₂+Ar+N₂ plasmas.

### DETAILED DESCRIPTION OF THE INVENTION

Surface deposits removed with this invention comprise those materials commonly deposited by chemical vapor deposition or plasma-enhanced chemical vapor deposition or similar processes. Such materials include silicon, doped silicon, silicon nitride, tungsten, silicon dioxide, silicon oxynitride, silicon carbide and various silicon oxygen compounds referred to as low K materials, such as FSG (fluorosilicate glass), silicon carbides and SiCₓOₓHₓ or PECVD OSG including Black Diamond (Applied Materials), Coral (Novellus Systems) and Aurora (ASM International). Preferred surface deposit in this invention is silicon nitride.

One embodiment of this invention is removing surface deposits from the interior of a process chamber that is used in fabricating electronic devices. Such a process chamber could be a Chemical Vapor Deposition (CVD) chamber or a Plasma Enhanced Chemical Vapor Deposition (PECVD) chamber.

Other embodiments of this invention include, but are not limited to, removing surface deposits from metals, the cleaning of plasma etching chambers and the stripping of photoresists.

The process of the present invention involves an activating step wherein a cleaning gas mixture will be activated in a remote chamber. Activation may be accomplished by any means allowing for the achievement of dissociation of a large fraction of the feed gas, such as: radio frequency (RF) energy, direct current (DC) energy, laser illumination and microwave energy. One embodiment of this invention is using transformer coupled inductively coupled lower frequency RF power sources in which the plasma has a torroidal configuration and acts as the secondary of the transformer. The use of lower frequency RF power allows the use of magnetic cores which enhance the inductive coupling with respect to capacitive coupling; thereby allowing the more efficient transfer of energy to the plasma without excessive ion bombardment which limits the lifetime of the remote plasma source chamber interior. Typical RF power used in this invention has frequency lower than 1,000 KHz. Another embodiment of the power source in this invention is a remote microwave, inductively, or capacitively coupled plasma source.

One embodiment of the invention involves an activating step using sufficient power for a sufficient time to form an activated gas mixture having neutral temperature of at least about 3,000 K. The neutral temperature of the resulting plasma depends on the power and the residence time of the gas mixture in the remote chamber. Under certain power input and conditions, neutral temperature will be higher with longer residence time. Here, preferred neutral temperature is over about 3,000 K. Under appropriate conditions (considering power, gas composition, gas pressure and gas residence time), neutral temperatures of at least about 6000 K may be achieved.

The activated gas is formed in a separate, remote chamber that is outside of the process chamber, but in close proximity to the process chamber. In this invention, remote chamber refers to the chamber wherein the plasma is generated, and process chamber refers to the chamber wherein the surface deposits are located. The remote chamber is connected to the process chamber by any means allowing for transfer of the activated gas from the remote chamber to the process chamber. For example, the transport passage may consist of a short connecting tube and a showerhead of the CVD/PECVD process chamber. The remote chamber and means for connecting the remote chamber with the process chamber are constructed of materials known in this field to be capable of containing activated gas mixtures. For instance, aluminum and anodized aluminum are commonly used for the chamber components. Sometimes Al₂O₃ is coated on the interior surface to reduce the surface recombination.

The gas mixture that is activated to form the activated gas comprises an oxygen source, sulfur fluoride and a nitrogen source. An “oxygen source” of the invention is herein referred to as a gas which can generate atomic oxygen in the activating step in this invention. Examples of an oxygen source here include, but are not limited to O₂ and nitrogen oxides. Nitrogen oxides of the invention is herein referred to as molecules consisting of nitrogen and oxygen. Examples of nitrogen oxides include, but are not limited to NO, N₂O, NO₂. Preferred oxygen source is oxygen gas. Unnecessary oxygen gas in the cleaning gas mixture will limit the etching rate. The preferred molar ratio of oxygen gas and sulfur fluoride is less than 5:1. Sulfur fluoride in this invention is SF₆, SF₅ or SF₄. Prefered sulfur fluoride is SF₆. A “nitrogen source” of the invention is herein referred to as a gas which can generate atomic nitrogen in the activating step in this invention. Examples of a nitrogen source here include, but are not limited to N₂, NF₃ and nitrogen oxides. Preferred nitrogen source is nitrogen gas.

The gas mixture that is activated to form the activated gas may further comprise a carrier gas such as argon and helium.

The total pressure in the remote chamber during the activating step may be between about 0.1 Torr and about 20 Torr.

It was found in this invention that a nitrogen source can dramatically increase the etching rate of sulfur fluoride on silicon nitrides. In one embodiment of this invention, as shown in Example 1 below, small amount of nitrogen gas addition can increase the SF₆/O₂/Ar cleaning gas mixture etching rate on silicon nitride by thirteen-fold. Actually, the SF₆/O₂/Ar/N₂ system in this invention can even outperform the NF₃/O₂/Ar system on etching rate under similar conditions. See also the comparative example 2.

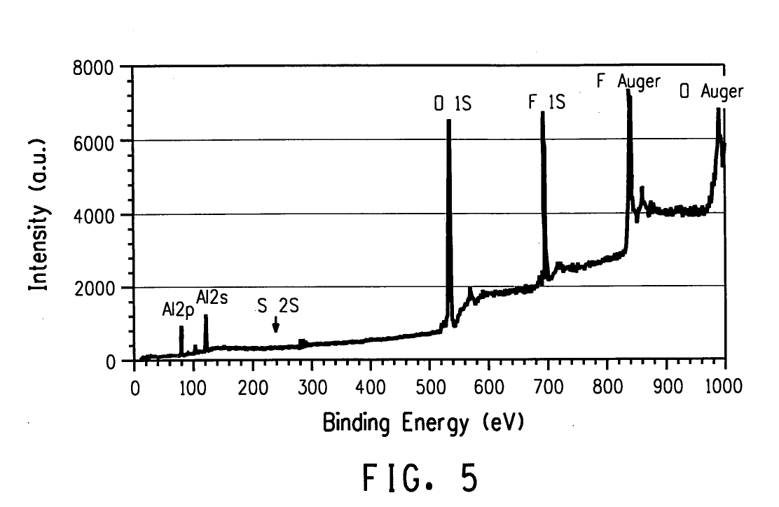

It was also found that under conditions of this invention, the interior surface of the process chamber had no sulfur deposition after the activated gas treatment. See also Example 4 and FIG. 5.

The following Examples are meant to illustrate the invention and are not meant to be limiting.

### EXAMPLES

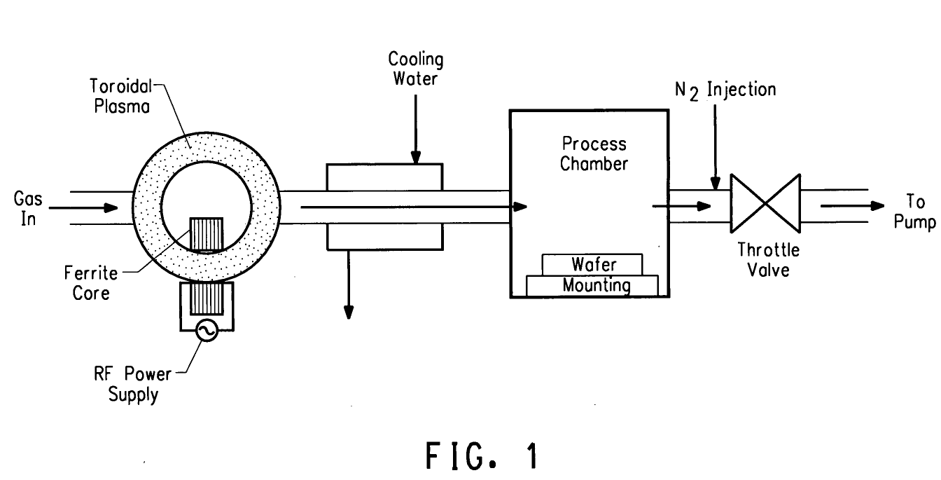

FIG. 1 shows a schematic diagram of the remote plasma source, transportation tube, process chamber and exhaust emission apparatus used in this invention. The remote plasma source is a commercial toroidal-type MKS ASTRON®ex reactive gas generator unit made by MKS Instruments, Andover, Mass., USA. The feed gases (e.g. oxygen, sulfur fluoride, NF₃, nitrogen source, Argon) were introduced into the remote plasma source from the left, and passed through the toroidal discharge where they were discharged by the 400 KHz radio-frequency power to form an activated gas mixture. The oxygen is manufactured by Airgas with 99.999% purity. The SF₆ is manufactured by Airgas with 99.8% purity and the NF₃ gas is manufactured by DuPont with 99.999% purity. Nitrogen gas is manufactured by Airgas with grade of 4.8 and Argon is manufactured by Airgas with grade of 5.0. The activated gas mixture then passed through an aluminum water-cooled heat exchanger to reduce the thermal loading of the aluminum process chamber. The surface deposits covered wafer was placed on a temperature controlled mounting in the process chamber. The neutral temperature is measured by Optical Emission Spectroscopy (OES), in which rovibrational transition bands of diatomic species like C₂ and N₂ are theoretically fitted to yield neutral temperature. See also B. Bai and H. Sawin, Journal of Vacuum Science & Technology A 22 (5), 2014 (2004), herein incorporated as a reference. The etching rate of the surface deposits by the activated gas is measured by interferometry equipment in the process chamber. N₂ gas is added at the entrance of the exhaustion pump both to dilute the products to a proper concentration for FTIR measurement and to reduce the hang-up of products in the pump. FTIR was used to measure the concentration of species in the pump exhaust.

### Example 1

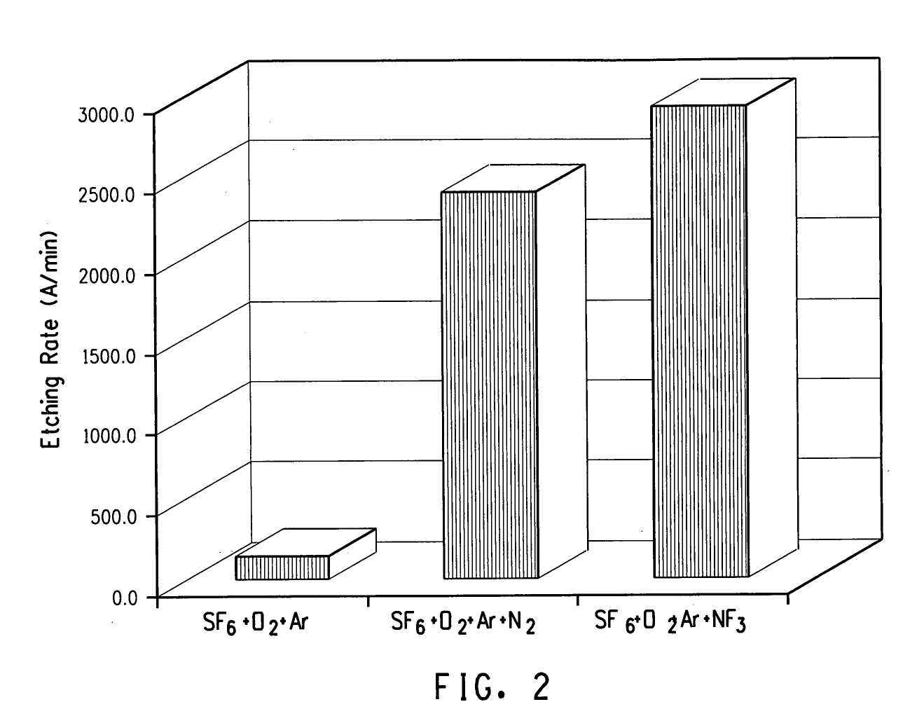

This Example demonstrated the effect of nitrogen source addition on the silicon nitride etching rate of SF₆/O₂/Ar systems. The results are also shown in FIG. 2. In this experiment, the feeding gas composed of O₂, SF₆, Ar and optionally N₂ or NF₃ wherein O₂ flow rate was 667 sccm, Ar flow rate was 2000 sccm, SF₆ flow rate was 667 sccm. Chamber pressure was 2 torr. The feeding gas was activated by the 400 KHz 4.8 Kw RF power to a neutral temperature more than 3000 K. The activated gas then entered the process chamber and etched the silicon nitride surface deposits on the mounting with the temperature controlled at 50° C. When there was no nitrogen source in the feeding gas mixture, i.e. the feeding gas mixture was composed of 667 sccm O₂, 2000 sccm Ar and 667 sccm SF₆, the etching rate was only 189 Å/min. As shown in middle column of FIG. 2, when 100 sccm N₂ was added in the feeding gas mixture, i.e. the feeding gas mixture was composed of 100 sccm N₂, 667 sccm O₂, 2000 sccm Ar and 667 sccm SF₆, the etching rate of silicon nitride was increased from 189 to 2465 Å/min. If instead 300 sccm NF₃ was added in the feeding gas mixture, i.e. the feeding gas mixture was composed of 300 sccm NF₃, 667 sccm O₂, 2000 sccm Ar and 667 sccm SF₆, the etching rate was increased to 2975 Å/min.

### Example 2 (Comparative)

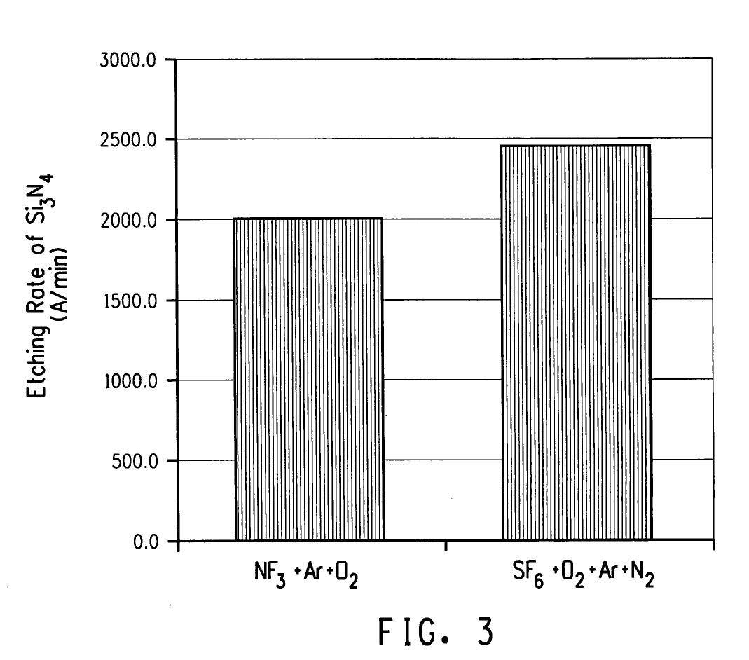

This Example showed the silicon nitride etching rate of NF₃/O₂/Ar systems under similar conditions as those in Example 1. The NF₃ flow rate was controlled at 1333 sccm, so that the total fluorine atom amount was the same as the one in Example 1. In this experiment, the feeding gas composed of O₂, NF₃ and Ar wherein O₂ flow rate was 200 sccm, Ar flow rate was 2667 sccm, NF₃ flow rate was 1333 sccm. Chamber pressure was 2 torr. The feeding gas was activated by the 400 KHz 4.6 Kw RF power to a neutral temperature more than 3000 K. The activated gas then entered the process chamber and etched the silicon nitride surface deposits on the mounting with the temperature controlled at 50° C. The etching rate was measured as 2000 Å/min, which was about 20% lower than that of SF₆/O₂/Ar/N₂ mixture. (See also FIG. 3)

### Example 3

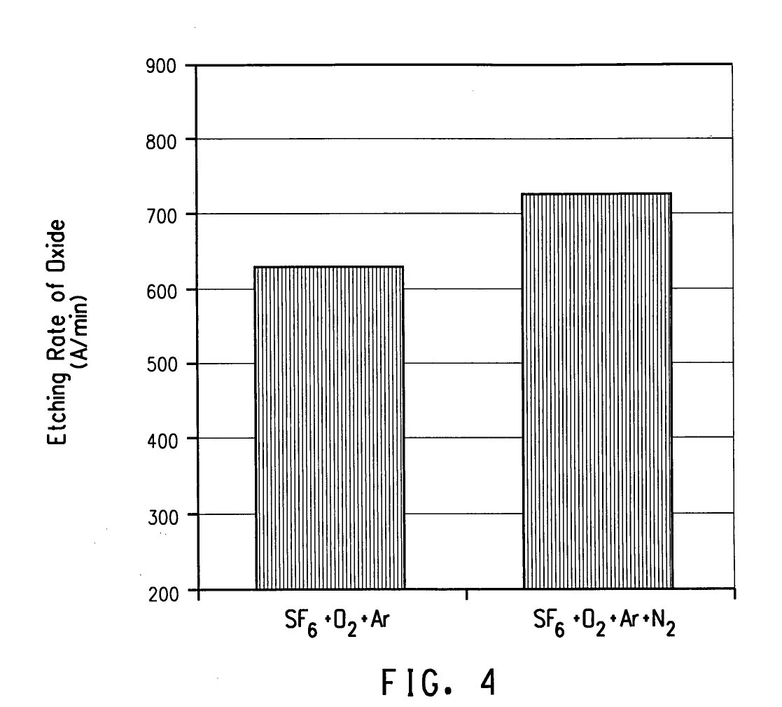

This Example demonstrated the effect of nitrogen source addition on the SiO₂ etching rate of SF₆/O₂/Ar systems. The results are also shown in FIG. 4. In this experiment, the feeding gas composed of O₂, SF₆, Ar and optionally N₂ wherein O₂ flow rate was 667 sccm, Ar flow rate was 2000 sccm, SF₆ flow rate was 667 sccm. Chamber pressure was 2 torr. The feeding gas was activated by the 400 KHz 4.8 Kw RF power to a neutral temperature more than 3000 K. The activated gas then entered the process chamber and etched the SiO₂ surface deposits on the mounting with the temperature controlled at 100° C. When there was no nitrogen source in the feeding gas mixture, i.e. the feeding gas mixture was composed of 667 sccm O₂, 2000 sccm Ar and 667 sccm SF₆, the etching rate was only 736 Å/min. When 100 sccm N₂ was added in the feeding gas mixture, i.e. the feeding gas mixture was composed of 100 sccm N₂, 667 sccm O₂, 2000 sccm Ar and 667 sccm SF₆, the etching rate of SiO₂ was increased from 736 to 854 Å/min.

### Example 4

In this experiment, the feeding gas composed of O₂, N₂, SF₆ and Ar, wherein O₂ flow rate was 667 sccm, N₂ flow was 100 sccm, Ar flow rate was 2000 sccm, SF₆ flow rate was 667 sccm. Chamber pressure was 2 torr. The feeding gas mixture was activated by the 400 KHz 4.8 Kw RF power to a neutral temperature more than 3000 K. The activated gas then entered the process chamber and treated for 10 minutes a Sapphire wafer surface on the mounting with the temperature controlled at 25° C. FIG. 5 demonstrates that the surface was clean from sulfur after treatment.

What is claimed is:

1. A method for removing surface deposits, said method comprising:
(a) activating in a remote chamber a gas mixture comprising an oxygen source, sulfur fluoride and a nitrogen source to form an activated gas mixture, and thereafter
(b) contacting said activated gas mixture with the surface deposits and thereby removing at least some of said surface deposits.

2. The method of claim 1, wherein said surface deposits is removed from the interior of a process chamber that is used in fabricating electronic devices.

3. The method of claim 1, wherein said oxygen source is oxygen gas or nitrogen oxides.

4. The method of claim 3, wherein said oxygen source is oxygen gas.

5. The method of claim 4, wherein the molar ratio of said oxygen gas and said sulfur fluoride is less than 5:1.

6. The method of claim 1, wherein said nitrogen source is nitrogen gas, NF₃, or nitrogen oxides.

7. The method of claim 6, wherein said nitrogen source is nitrogen gas.

8. The method of claim 1, wherein the surface deposit is selected from a group consisting of silicon, doped silicon, silicon nitride, tungsten, silicon dioxide, silicon oxynitride, silicon carbide and various silicon oxygen compounds referred to as low K materials.

9. The method of claim 8, wherein the surface deposit is silicon nitride.

10. The method of claim 1, wherein said gas mixture is activated using sufficient power for a sufficient time such that said gas mixture reaches a neutral temperature of at least about 3,000 K.

11. The method of claim 10, wherein said power is generated by a RF source, a DC source or a microwave source.

12. The method of claim 11, wherein said power is generated by a RF source.

13. The method of claim 12, wherein said RF power is transformer coupled inductively coupled having frequency lower than 1,000 KHz.

14. The method of claim 10, wherein the pressure in the remote chamber is between 0.1 Torr and 20 Torr.

15. The method of claim 1, wherein said gas mixture further comprises a carrier gas.

16. The method of claim 15, wherein said carrier gas is at least one gas selected from the group of gases consisting of argon and helium.

17. The method of claim 1, wherein said sulfur fluoride is SF₆.
